(19) United States
(12) Patent Application Publication
(10) Pub. No.: US 2002/0078375 A1
(43) Pub. Date: Jun. 20, 2002

(54) Portable player security system

(76) Inventor: Keven D. Coates, Cypress, TX (US)

Correspondence Address: TEXAS INSTRUMENTS INCORPORATED, P O BOX 655474, M/S 3999, DALLAS, TX, 75265

(21) Appl. No.: 09/998,786

(22) Filed: Dec. 3, 2001

Related U.S. Application Data
(60) Provisional application No. 60/255,893, filed on Dec. 18, 2000.

(51) Int. Cl. H04L 9/32

(52) U.S. Cl. 713/200

(57) ABSTRACT

An MP3 player 10 is provided a security lock to prevent theft using a combination of the player keys 21-27. According to one embodiment in the event the authorized user forgets the code the player can provide a hint to the user of the security code for the user. According to another embodiment an unlock can be provided by a modem connection to the manufacturer.

### FIELD OF THE INVENTION

This invention relates to portable players and, more particularly, to a portable player with a theft security system.

### BACKGROUND OF THE INVENTION

The audio compression technology known as MP3 or MPEG Audio Player 3 uses perceptual audio coding to compress CD-quality or near CD-quality sound while providing almost the same fidelity. The MP3 is part of the MPEG-1 and MPEG-2 specifications. That compression factor is about 12. MP3 music files are played via software on a personal computer (PC) or a physical player that cables to a PC for transfer.

MP3 players present a pocket sized player without any CD drive mechanization or moving parts to play music or other information downloaded by a cable from the web via a personal computer (PC). Typical players such as the RIO MP3 player of Diamond Multimedia have 16 or 32 megabytes (MB) flash memory for storing the downloaded data from the web. Another product is from Compaq (Compaq iPAQ or Personal Audio Player PA-1 that has 64 MB of MMC Memory for storing up to 2 hours of digital music. This player also supports the WMA and AAC formats. Copyrighted music or other information such as books can be downloaded for a fee or offered free. A typical 32 MB flash memory card can store about one hour of audio. The Compaq player has two replaceable cards.

An hour of music can be downloaded into the flash memory in about five minutes. For more information, see www.mp3.com.

A problem with such small players is that they are easily taken by unauthorized persons. The small handheld ones have only a space for a few keys to operate the system.

### SUMMARY OF THE INVENTION

In accordance with one embodiment of the present invention, an owner can lock and unlock the player when not in use by inputting a security code using the player's keys.

### DESCRIPTION OF THE DRAWINGS

FIG. 1 illustrates an MP3 player; and

FIG. 2 illustrates the security circuit for the player of FIG. 1.

### DESCRIPTION OF PREFERRED EMBODIMENT

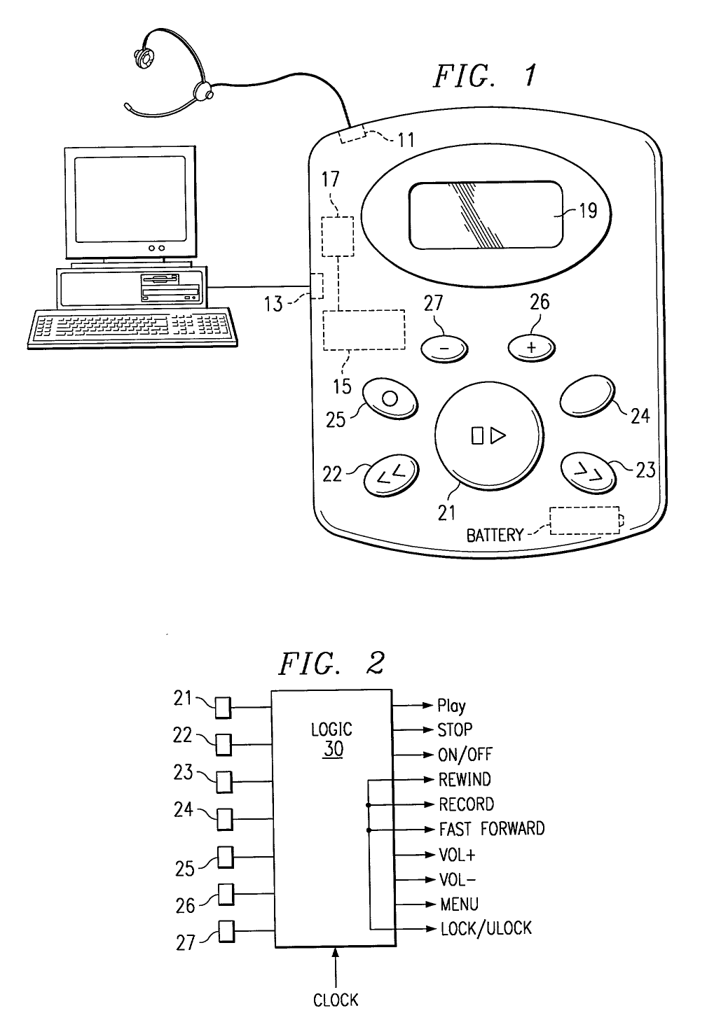

Referring to FIG. 1, there is illustrated an MP3 player 10 according to one embodiment of the present invention. The player 10 includes an ear phone jack 11 to attach headphone speakers and a PC port 13 to receive the MP3 compressed music or other audio data via cable from a personal computer via the web. The player 10 includes the flash memory 15 and a microcontroller or microcomputer or DSP 17 for storing the data and decoding the data on the memory 15. The player 10 includes a display 19 such as a liquid crystal display (LCD) to display the name of the audio, the time run, the settings and keyed positions. Separate keys 21-27 select the functions such as play, rewind, fast forward, record, on-off, volume up or volume down, stop and a menu. The settings can be displayed on the display 19. A key may also be provided to activate the security. According to a preferred embodiment of the present invention illustrated in FIG. 2, the normal player keys 21-27 for play, stop, rewind, etc., are used to set a security code. In the embodiment shown in FIG. 2 the simultaneous depressing of the rewind, record and fast forward keys locks and unlocks the security. Well known logic circuits 30 can AND this combination at a given time window. The code could be any combination or length, preferable from three to six key presses, sequentially or at the same time. The player could display on display 19 a hint such as a keyword to which only the user could relate as to the code to lock or unlock by depressing a menu key or key combination.

If the user turns the unit off with security on, the code is then required to operate the player again. If the user forgets the code, a timer (three weeks, for example) may unlock the player security automatically. Another option is if the user forgets the code, there would be a code from the manufacturer that would unlock the player. This could be accomplished over a modem while the player is connected to the PC, or through a program that could be written to the flash media (if external).

What is claimed is:

1. An audio player system comprising:
a memory,
a processor and control keys to normally operate the player,
a circuit responsive to said keyed inputs from said keys for security locking the player from playing or recording.

2. The player of claim 1 wherein said keyed inputs are a combination of normally used keyed inputs to operate the player.

3. The player of claim 2 wherein said player is an MP3 player.

4. The player of claim 3 wherein if the user forgets the security code, the system displays a hint.

5. The player of claim 3 wherein if the user forgets the security code for a predetermined period of time the system becomes unlocked.

6. The player of claim 3 wherein the manufacturer can provide an unlocked security code over the modem connection to a personal computer cabled to the player.

7. A method of providing security to a player comprising the steps of:
providing a security lock to the player;
keying in an unlocked code by a combination of key presses to one or more of the normal operation keys.

8. The method of claim 7 wherein the key presses are made sequentially.

9. The method of claim 7 wherein the key presses are made at the same time.
